(19) United States
(12) Patent Application Publication
(10) Pub. No.: US 2006/0275677 A1
(43) Pub. Date: Dec. 7, 2006

(54) Imaging forming method, printed product and image forming medium

(76) Inventor: Yukio Okamoto, Tokyo (JP)

Correspondence Address: CANTOR COLBURN, LLP, 55 GRIFFIN ROAD SOUTH, BLOOMFIELD, CT, 06002, US

(21) Appl. No.: 11/374,226

(22) Filed: Mar. 13, 2006

(30) Foreign Application Priority Data
Jun. 6, 2005 (JP) JP2005-165325

(51) Int. Cl. G03C 3/00; G03G 13/01; G03G 13/20

(52) U.S. Cl. 430/18; 430/124; 430/42; 399/342

(57) ABSTRACT

An image forming method includes the steps of forming a mirror image on a transparent substrate by an electrophotographic process, and laminating a light reflecting material having an adhering or tacking layer onto an image bearing surface of the transparent substrate, wherein the transparent substrate and the light reflecting material that are used to form the image satisfy a condition R1⊃R2, R1 indicating a region of the transparent substrate and R2 indicating a region of the light reflecting material.

### FIELD OF THE INVENTION

The present invention relates to an image forming method that forms an image by an electrophotographic process, and relates to a material for print and image forming.

### BACKGROUND OF THE INVENTION

In color photography, characteristics exceeding those of character images or line images are required in terms of image qualities such as image tones, graininess, and color reproduction of an image. Desired characteristics are also required with regard to the glossiness of the surface of a photograph. That is, photographs are desired which are mirror-finished and glossy or finished in a matt surface, which is called a silk surface.

For silver halide photography, such surface characteristics are gained by performing mirror processing or silk processing in a step after developing and fixing.

For electrophotography, as disclosed in Patent Document 1, methods are offered which form an image on a transparent film and laminate a backup layer onto the image bearing surface of the transparent film so that the surface of the transparent film becomes the surface of a photograph, thereby producing a glossy photograph.

[Patent Document 1]

TOKKAIHEI No. 7-56409(Japanese Non-Examined Patent Publication)

In an image forming method, as disclosed in Patent Document 1, which forms an image through a laminating step after image formation, prints produced through the laminating step are conveyed in an image forming device, ejected from the device, and then stacked on an ejection tray or the like. When an adhering or tacking layer is exposed as a part of an outer surface of a printed product produced through laminating by adhesion or tacking, a problem is caused in handling the print, such as conveying and stacking. For example, a trouble is winding of the print around a conveying roller or a belt.

In accordance with the invention, it is possible to form an image having a desired surface characteristic, that is, a glossy image, for example. Further, a primary object of the invention is to solve a problem, such as described above, during handling prints, for example, conveying and stacking the prints.

An image forming device that forms an image by an electrophotographic process is, in general, designed to be able to form photographic images and document images, having a capacity of forming an image in a large size, with a maximum size A3 for example. With an image forming device that forms an image by an electrophotographic process, it cannot be avoided that margins are formed surrounding an image, due to limitation of the structure of a process section that carries out various steps in image forming. Accordingly, in the case of forming an image in a smaller size, such as a photographic image, or forming a marginless print, a cutting step is required as a post-processing after image forming. However, in the case of cutting after laminating, cut swarf after cutting remains in the device, causing a problem of disposing the cut swarf. Further, image information is partially lost through cutting. It is also desired to solve problems caused in the case of producing marginless prints through cutting as described above.

### SUMMARY OF THE INVENTION

In an aspect of the invention, there is provided an image forming method that includes the steps of: forming a mirror image on a transparent substrate by an electrophotographic process; and laminating a light reflecting material having an adhering or tacking layer onto an image bearing surface of the transparent substrate, wherein the transparent substrate and the light reflecting material that are used to form the image satisfy a condition R1⊃R2, R1 indicating a region of the transparent substrate and R2 indicating a region of the light reflecting material.

### BRIEF DESCRIPTION OF THE DRAWINGS

FIG. 1 is a diagram showing steps of an image forming method in accordance with Embodiment 1 of the invention;

FIG. 2 is a diagram showing steps of an image forming method in Embodiment 2 of the invention;

FIG. 3 is a diagram showing steps of an image forming method in Embodiment 3 of the invention;

FIG. 4 is a diagram showing steps of an image forming method in Embodiment 4 of the invention;

FIG. 5 is a cross-sectional view of a light reflecting material;

FIG. 6A and FIG. 6B are diagrams showing examples of materials for image forming;

FIG. 7 is a diagram showing a color image forming apparatus which is a first example of an apparatus that carries out an image forming method in accordance with an embodiment of the invention;

FIG. 8 is a diagram showing an image processing unit for forming a mirror image;

FIG. 9 is a diagram illustrating reading out from an image memory;

FIG. 10 is a diagram showing a color image forming apparatus which is a second example of an apparatus that carries out an image forming method in accordance with an embodiment of the invention; and

FIG. 11 is a diagram showing a color image forming apparatus which is a third example of an apparatus that carries out an image forming method in accordance with an embodiment of the invention.

### DESCRIPTION OF PREFERRED EMBODIMENTS OF THE INVENTION

Preferred embodiments of the invention will be described below. However, but the invention is not limited to the following embodiments.

1. Image Forming Method 1-1

### Embodiment 1

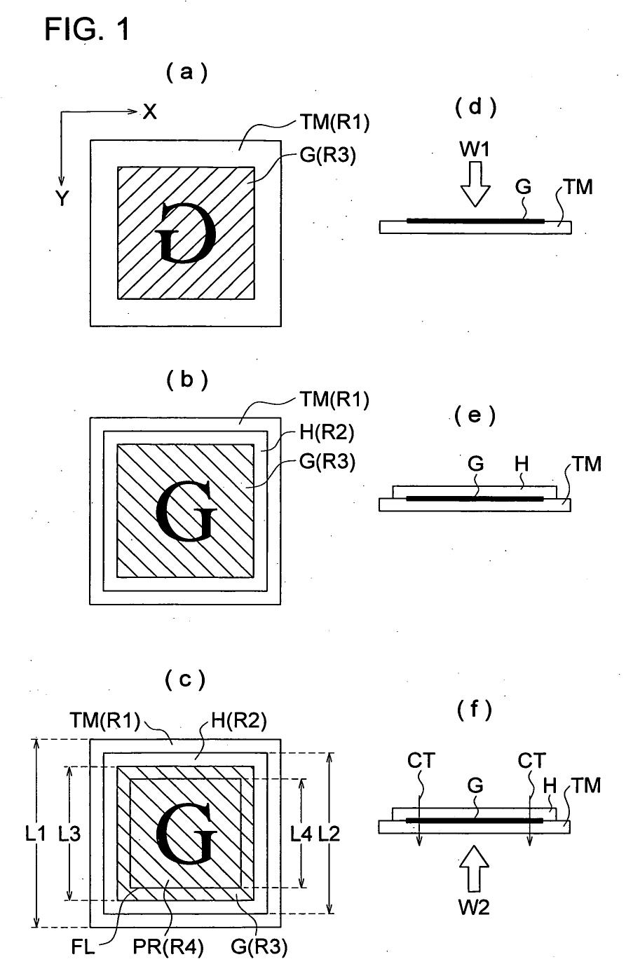

FIG. 1 is a diagram showing the steps of an image forming method in accordance with Embodiment 1 of the invention.

The image forming method in accordance with the present embodiment is an example of a case where a transparent substrate in a cut-sheet form and a light reflecting material in a cut-sheet form are used. The method includes an image forming step, laminating step, and cutting step.

In FIG. 1, diagrams (a) to (c) are plane views, and diagrams (d) to (f) are cross-sectional views along direction x or direction y in diagram (a).

(1) Image Forming Step

The image forming step forms a toner image G which is a mirror image on a transparent substrate TM by an electrophotographic method as shown in FIG. 1 (a) and (d).

Specifically, an electrostatic latent image is formed on a photoreceptor by charging and exposing the photoreceptor, and a toner image is formed on the photoreceptor by developing the formed electrostatic latent image.

The toner image on the photoreceptor is transferred onto the transparent substrate TM and fixed.

The transfer from the photoreceptor to the transparent substrate TM is performed by direct transfer or indirect transfer through an intermediate transfer body.

Toner image G formed on the transparent substrate TM is, as shown, a mirror image reversed left-and-right or upside-down from the original image, when viewed from the image bearing side, shown by W1, of the transparent substrate TM.

Toner image G having been transferred to the transparent substrate TM is fixed.

(2) Laminating Step

The light reflecting material H having an adhering or tacking layer is laminated on the transparent substrate TM formed with the image, as shown in diagrams (b) and (e) in FIG. 1, by jointing the image bearing surface of the transparent substrate TM and the adhering or tacking layer.

(3) Cutting Step

The lamination of the transparent substrate TM and the light reflecting material H is cut, as shown in diagrams (c) and (f) in FIG. 1, along a frame FL of a cutter CT into a desired size.

If a printed product PR produced by cutting, as described above, is viewed from the side of the transparent substrate TM, as shown by arrow W2, a right image can be observed.

Denoting the region of the transparent substrate TM by R1, the region of the light reflecting material H by R2, the region of toner image G by R3, and the region of print PR having been cut by R4, the employed transparent substrate TM and the light reflecting material H are those that satisfy a condition 1 as follows.
R1⊃R2⊃R3⊃R4 (condition 1)
The formed toner image G is cut.

The finished print PR is formed with an image which is right when viewed in direction W2, namely viewed from the side of the transparent substrate TM.

Above condition 1 can be replaced by condition 2 as follows with regard to lengths L1, L2, L3, and L4.
L1>L2≧L3≧L4 (condition 2)

Condition 2 is satisfied if L1 to L4 are applied to lengths of regions R1 to R4, along both directions x and y which are orthogonal to each other, as shown in diagram (a) of FIG. 1.

In other words, in the image forming step, the transparent substrate is conveyed and image forming processing is performed on the moving transparent substrate in the image forming apparatus, as later described, wherein condition 2 is satisfied both in the conveying direction of the transparent substrate and in the direction orthogonal to the conveying direction in applying lengths L1 to L4 to the maximum lengths of the respective regions R1 to R4.

Herein, it is preferable to minimize the part, of the region R3 of toner image G, which is removed out of the image region R4 by cutting, namely, to preferably minimize the region in a width of (L3−L4)/2 to be in a range [(L3−L4)/2]≦5 mm.

According to condition 1 (or condition 2), the light reflecting material H is entirely covered by the transparent substrate TM so that the adhering or tacking layer of the light reflecting material H is not exposed, and accordingly images of desired surface characteristics can be produced, and smooth conveying and stacking of prints can be performed. Further, in producing marginless prints, toner image G is formed in a region that is inside the region of the transparent substrate TM, in other words, toner image G is not formed in a region which spreads outside the transparent substrate TM. Accordingly, the phenomenon that toner splashes does not occur, which prevents staining of images and the inside of the apparatus which could be caused by splash of toner. Still further, cut swarf is prevented from adhering to the inside of the apparatus, and the amount of a part, of the image region R3, which is cut off and disposed is reduced, thereby decreasing image information which could be lost by cutting.

### 1-2. Embodiment 2

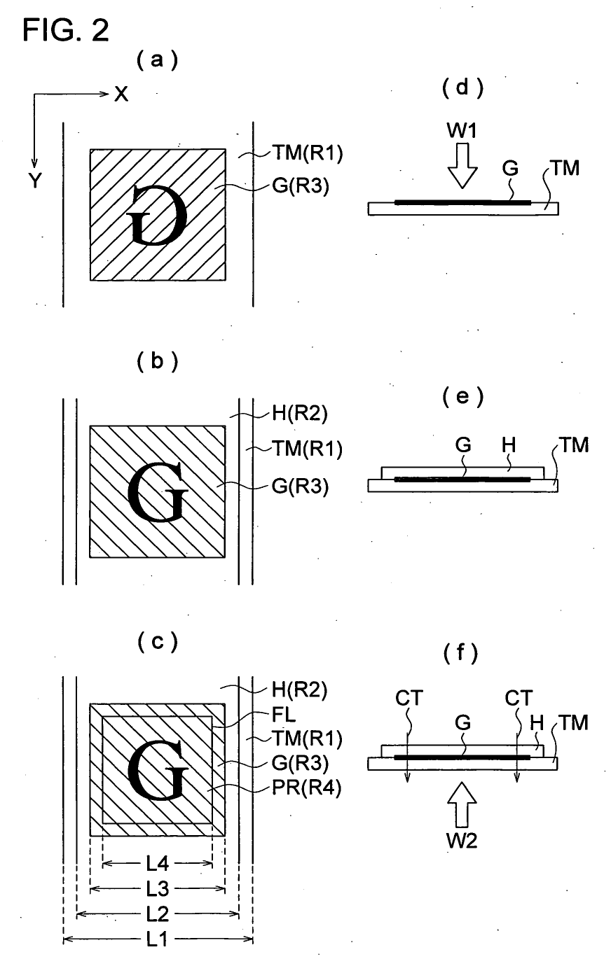

FIG. 2 is a diagram showing steps of an image forming method in embodiment 2 of the invention.

The image forming method in accordance with the present embodiment is an example of employing a band formed image forming medium, and includes an image forming step, a laminating step, and a cutting step.

Diagrams (a) to (c) in FIG. 2 are plane views, and diagrams (d) to (f) are cross-sectional views of the band formed transparent substrate TM and the light reflecting material H along the lateral direction, namely, direction x.

Toner image G is formed on the transparent substrate TM, as shown in diagrams (a) and (d) in FIG. 2. The light reflecting material H is laminated on the image bearing surface of the transparent substrate TM, in diagrams (b) and (e) of FIG. 2. The lamination is cut along the frame FL, in diagrams (c) and (f) in FIG. 2.

In FIG. 2, condition 1, namely, R1⊃R2⊃R3⊃R4 can be replaced by condition 2, that is,
L1>L2≧L3≧L4
with regard to lengths L1 to L4 along the lateral direction of the band formed transparent substrate TM and the light reflecting material, namely, direction x.

### 1-3. Embodiment 3

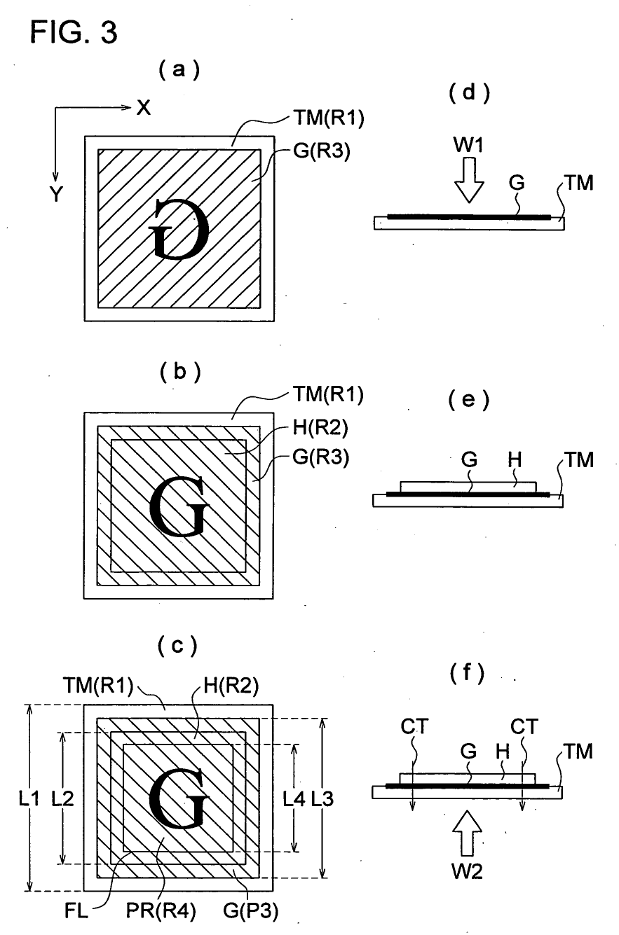

FIG. 3 is a diagram showing steps of an image forming method in accordance with Embodiment 3 of the invention.

The image forming method in accordance with the present embodiment is an example of a case wherein a transparent substrate and a light reflecting material in a cut-sheet form are used, and the method includes an image forming step, laminating step, and cutting step.

In FIG. 3, diagrams (a) to (c) are plane views, and diagrams (d) to (f) are cross-sectional views along direction x or direction y in diagram (a).

The image forming step, laminating step, and cutting step are performed, as shown in diagrams (a) to (f) of FIG. 3, likewise, as described above regarding FIG. 1. However, in the present embodiment, the image forming step, laminating step, and cutting step are performed, satisfying the following condition 3 between region R1 of the transparent substrate TM, region R2 of the light reflecting material H, region R3 of toner image G, and region R4 of the cut print PR.
R1⊃R3⊃R2⊃R4 (condition 3)

Accordingly, the following condition 4 is satisfied, with regard to the maximum lengths L1 to L4 of the respective regions in direction x and direction y.
L1>L3≧L2≧L4 (condition 4)

By satisfying condition 3 (or condition 4), the light reflecting material H is entirely covered by the transparent substrate TM. Therefore, the adhering or tacking layer of the light reflecting material H is prevented from being exposed, images of desired surface characteristics can be produced, and smooth conveying and stacking of prints can be performed. Further, in producing marginless prints, toner image G is formed in a region that is inside the region of the transparent substrate TM, in other words, toner image G is not formed in a region which spreads outside the transparent substrate TM. Accordingly, the phenomenon that toner splashes does not occur, which prevents staining of images and the inside of the apparatus which could be caused by splash of toner. Still further, cut swarf is prevented from adhering to the inside of the apparatus, and the amount, of the light reflecting material H, which is cut off and disposed through the cutting step is reduced, thereby decreasing the waste.

### 1-4. Embodiment 4

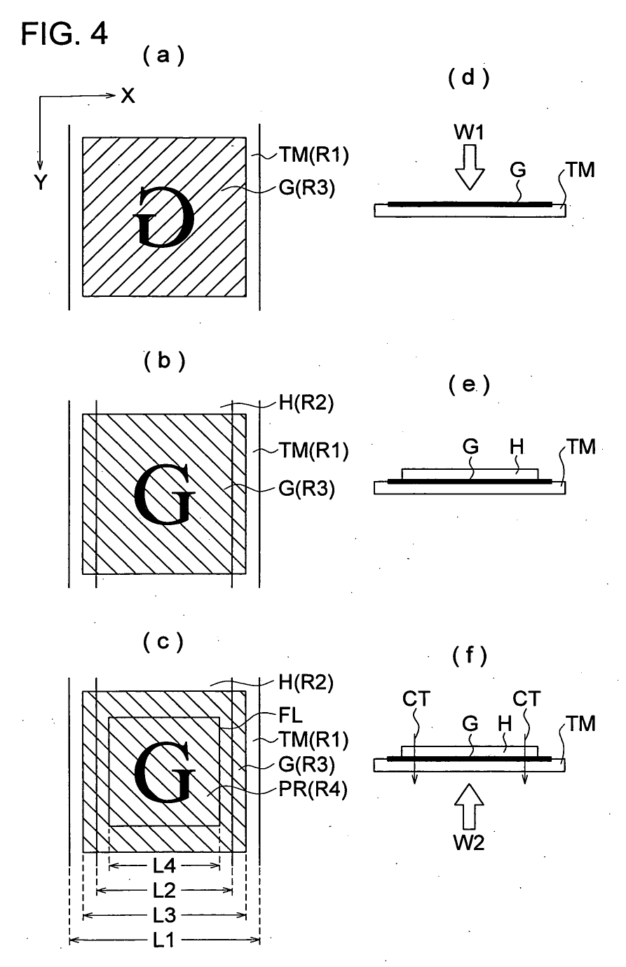

FIG. 4 is a diagram showing steps of an image forming method in Embodiment 4 of the invention.

The image forming method in accordance with the present embodiment is an example of employing a band formed image forming medium, and includes an image forming step, a laminating step, and a cutting step.

Diagrams (a) to (c) of FIG. 4 are plane views, and diagrams (d) to (f) are cross-sectional views along direction x in diagram (a).

The image forming step, laminating step, and cutting step are performed, likewise as described above referring to diagrams (a) to (f) of FIG. 2. However, in the present embodiment, the image forming step, laminating step, and cutting step are performed, satisfying the following condition 3 between region R1 of the transparent substrate TM, region R2 of the light reflecting material H, region R3 of toner image G, and region R4 of the cut print PR.
R1⊃R3⊃R2⊃R4 (condition 3)

Accordingly, the following condition 4 is satisfied, with regard to the maximum lengths L1 to L4 of the respective regions in direction x.
L1>L3≧L2≧L4 (condition 4)
<Image Forming Medium>

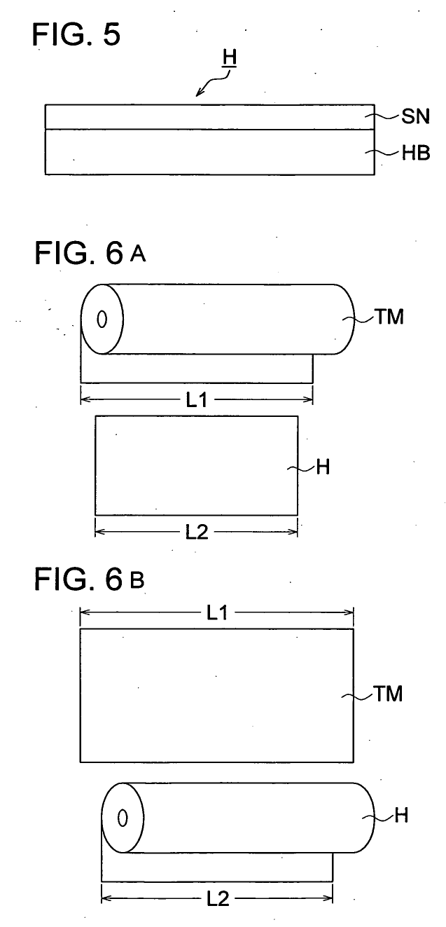

The image forming medium in accordance with the present embodiment is a lamination of the transparent substrate TM and the light reflecting material H, and the light reflecting material H has a light reflecting substrate HB and an adhering or tacking layer SN, as shown in FIG. 5.

The transparent substrate TM is preferably a PET (polyethylene terephthalate) film, and preferably has a thickness in a range from 50 to 500 μm.

If the thickness is smaller than 50 μm, the tone image may cause roughness of the surface of a photographic print. On the other hand, if the thickness is larger than 500 μm, a trouble may be caused in processing in an ordinary electrophotographic image forming apparatus.

Further, in the case of using the transparent substrate TM as a recording medium for image forming by an electrophotograpchic method, the surface resistivity of the transparent substrate TM is preferably in a range 10⁷ ohms square to 10¹² ohms square. If the surface resistivity is lower than 10⁷ ohms square, leakage of charges in the surface direction makes it difficult to perform satisfactory transfer, and may degrades the image quality. If the surface resistivity is higher than 10¹² ohms square, unnecessary charging occurs to cause a problem in conveyance in the image forming apparatus or degrade the image quality.

In order to set a proper resistance value of the transparent substrate TM, as described above, an antistatic layer containing an organic or inorganic conductive material is preferably provided at least on one surface of the transparent substrate TM.

The light reflecting material H has, as shown in FIG. 5, a light reflecting substrate HB and an adhering or tacking layer SN.

The adhering or tacking layer SN is formed by coating an adhesive or tacking agent on the light reflecting substrate HB.

As the adhesive, a known adhesive, such as a solvent acrylic adhesive, emulsion type adhesive, can be employed.

The light reflecting substrate HB is a light reflective sheet in a color, such as white, translucent white, or silver, and is preferably a printing coated paper, a synthetic paper (name of commodity YUPO, etc.), resin-coated paper, or a resin film.

If a coated paper containing polyolefins, such as paraffin, polyethylene and polypropylene, is used, these components are compatible with the toner wax to serve as an adhering layer. Thus, it is possible to tightly bind the transparent substrate and the light reflecting material by using a coated paper containing a material compatible with the wax and through heat adhering. In such a manner, a coated layer that reflects light may sometimes serve as a tacking layer SN.

A transparent substrate TM and a light reflecting material H are supplied in a pair to the market as an image forming medium.

An image forming medium in a cut-sheet form including a transparent substrate and a light reflecting material will be described, referring to FIG. 1.

The transparent substrate TM and the light reflecting material H are supplied to the market in a pair of cut-sheets that satisfy, as shown in FIG. 1, the condition R1⊃R2, namely, L1>L2 with regard to directions x and y.

A case wherein a transparent substrate and a light reflecting material are used for an image forming medium in a band form will be described, referring to FIG. 2.

The transparent substrate TM and the light reflecting material H are supplied to the market in a pair of rolls in a band form that satisfy the condition R1⊃R2, namely, L1>L2 with regard to the direction x, which is the lateral direction of the band.

FIG. 6A shows a case where an image forming medium includes a transparent substrate in band form and a light reflecting material in a cut-sheet form. FIG. 6B shows a case where an image forming medium includes a transparent substrate in a cut-sheet form and a light reflecting material in a band form.

In FIG. 6A, a transparent substrate TM in a band form and a light reflecting material H in a cut-sheet form are employed for an image forming medium. Such an image forming medium is supplied to the market also as a pair of a medium in a band form and a medium in a cut-sheet form which satisfy the condition L1>L2 with regard to the lengths L1 and L2 in direction x in FIGS. 1 and 2, namely, the width L1 of the transparent substrate TM in a band form and the length L2 of the longer side of the light reflecting material H in a cut-sheet form.

In FIG. 6B, a transparent substrate TM in a cut-sheet form and a light reflecting material H in a band form are employed for an image forming medium. Such an image forming medium is also supplied to the market as a pair of a medium in a cut-sheet form and a medium in a band form which satisfy the condition L1>L2 with regard to the lengths L1 and L2 in direction x in FIGS. 1 and 2, namely, the length L1 of the longer side of the transparent substrate TM in a cut-sheet form and the width L2 of the light reflecting material H in a band-form.

3. Image Forming Apparatus

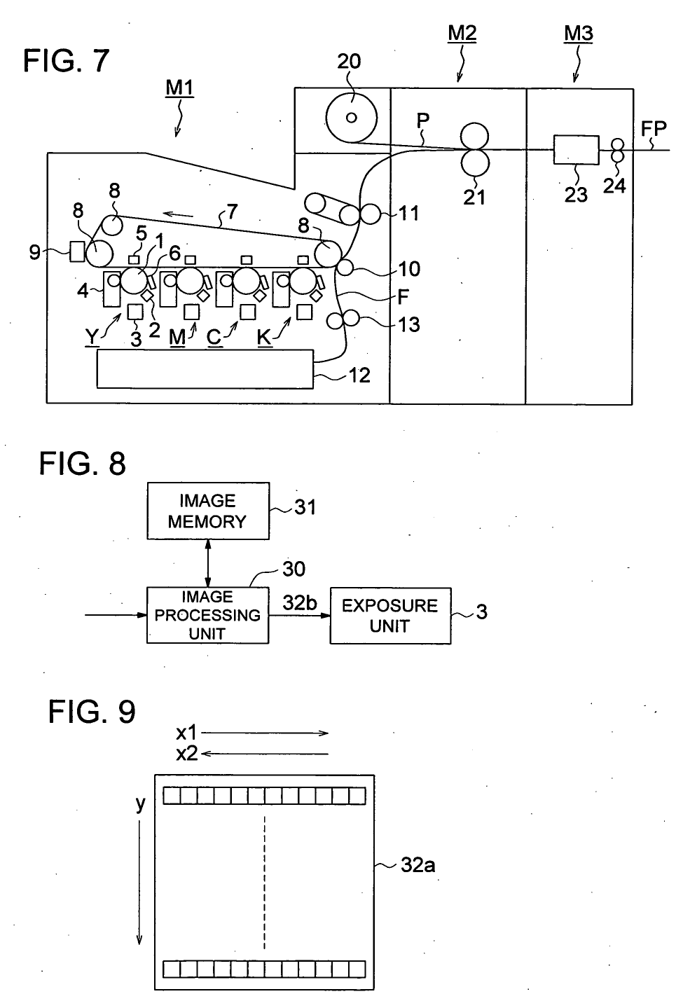

FIG. 7 is a diagram showing a color image forming apparatus which is a first example of an apparatus to perform the image forming method in accordance with the present embodiment of the invention.

The color image forming apparatus includes an image forming section M1, a laminating section M2, and a cutting section M3.

The image forming section includes an image forming unit Y that forms yellow toner images, an image forming unit M that forms magenta toner images, an image forming unit C that forms cyan toner images, and an image forming unit K that forms black toner images.

The image forming units Y, M, C, and K have the same structure. Therefore, reference symbols for elements are given on those of the image forming unit Y only, and reference symbols for elements of the other image forming units are omitted, and operation of the image forming unit Y will be described below. The image forming units M, C, and K also operate likewise.

A charging unit 2, exposure unit 3, developing unit 4, primary transfer unit 5, and a cleaning unit 6 are disposed around a photoreceptor 1 in a drum-shape.

In image forming, the photoreceptor 1 rotates clockwise; charging by the charging unit 2 and exposure by the exposure unit 3 form an electrostatic latent image on the photoreceptor 1; and the formed electrostatic latent image is developed by the developing unit 4 to form a toner image on the photoreceptor 1.

The toner image on the photoreceptor 1 is transferred by the primary transfer unit 5 to an intermediate transfer body 7.

On the intermediate transfer body 7 which is tension-supported by a plurality of support rollers 8 and moves in the arrow direction, an yellow toner image formed by the image forming unit Y, a magenta toner image formed by the image forming unit M, a cyan toner image formed by the image forming unit C, and a black toner image formed by the image forming unit K are superimposingly transferred so that a toner image in multiple colors is formed.

The toner image in multiple colors on the intermediate transfer body 7 is transferred to a transparent film F by a secondary transfer unit 10.

Transparent films F, being transparent substrates, are stored in a cassette 12 and supplied to the transfer section one by one by feeding rollers 13.

As the charging unit 2, a scorotron charger having a discharge electrode and a grid is preferably employed.

As the exposure unit 3, an exposure device that emits light, according to image data, and performs dot exposure on the photoreceptor 1 is preferably used, such as a laser scanning exposure device and an LED array exposure device.

As the developing unit 4, preferably used is a developing device that performs reversal development by the use of a two-component developer with major components which are the aforementioned wax containing toner, in accordance with embodiments of the invention, and a carrier.

As the primary transfer unit 5 and the secondary transfer unit 10, a scorotron charger having a transfer roller applied with a transfer voltage or a discharge electrode is preferably used.

As the cleaning units 6 and 9, blade cleaning devices using an elastic blade are preferably employed.

As a fixing unit 11, preferably used is a heat roller fixing device using a roller as a heating member and a press member, or a belt fixing device using a belt for at least one of a heating member and a press member.

The transparent film F bearing the transferred toner image in multiple colors passes through the fixing unit 11 to be subjected to fixing processing, ejected from the image forming section M1, and conveyed to the laminating section M2. In the laminating section M2, a sheet P in a roll form as a light reflecting material is laminated on a transparent film F and passes through the nip between paired press rollers 21. The sheet P as a light reflecting material is a white paper formed with a layer of a hotmelt adhesive or tacking agent. Herein, the transparent film F and the sheet P are laminated to each other by adhering or tacking. Adhering or tacking is performed by pressing or heating-and-pressing by the paired press rollers 21.

The composite formed by laminating, namely, a printed product FP is conveyed to the cutting section M3, cut by a cutter 23 in the cutting section M3 to be formed into a printed product in a sheet form, and ejected from the cutting section M3 by ejection rollers 24.

In the image forming units Y, M, C, and K, the exposure units 3 perform exposure to form respective mirror images on the photoreceptors 1. These mirror images are formed through image processing by an image processing unit shown in FIG. 8. FIG. 8 shows the image processing unit for forming mirror images.

The image processing unit 30 to generate image data that drives the exposure units 3 reads image data from an image memory 31 and generates image data 32b. When forming a mirror image, the image processing unit 30 reads out image data 32a that is stored in the image memory 31, along the main scan direction in the order x2 which is opposite to the order x1 applied at the time of writing, as shown in FIG. 9, and reads out image data 32a along the sub-scan direction, in the order y applied at the time of writing, to form the image data 32b.

The mirror image formed on the photoreceptor 1 becomes a right image on the intermediate transfer body 7, and gets transferred to the transparent film F to become a mirror image.

The mirror image on the transparent film F is observed to be a right image when a printed product FP, which is produced by laminating the transparent film F and a sheet P, is viewed from the side of the transparent film F.

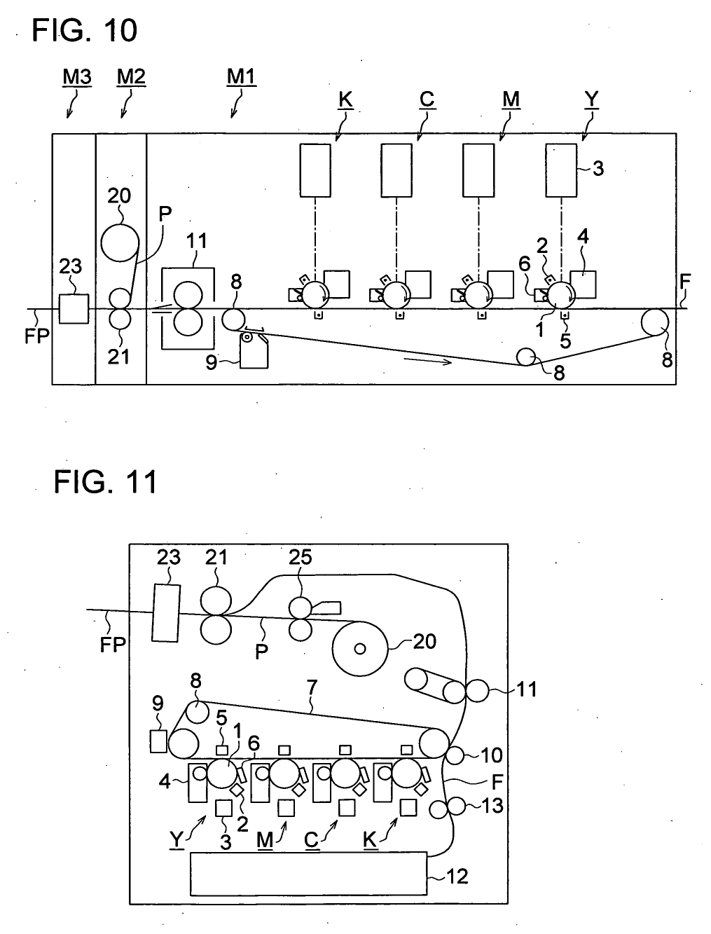

FIG. 10 is a diagram showing a color image forming apparatus in a second embodiment of the invention.

An image forming section includes an image forming unit Y that forms yellow toner images, an image forming unit M that forms magenta toner images, an image forming unit C that forms cyan tone images, and an image forming unit K that forms black tone images.

Since the image forming units Y, M, C, and K have a common structure, reference symbols for elements are given only to those of the structure of the image forming unit Y, and reference symbols for others are omitted. The operation of the image forming unit Y will be described below, wherein operation of the image forming units M, C, and K are similar to that of the image forming unit Y.

A charging unit 2, exposure unit 3, developing unit 4, transfer unit 5, and cleaning unit 6 are disposed around the photoreceptor 1 in a drum form.

In image forming, the photoreceptor 1 rotates clockwise; an electrostatic latent image is formed on the photoreceptor 1 by charging with the charging unit 2 and exposure with the exposure unit 3; and the formed electrostatic latent image is developed by the developing unit 4 to form a toner image on the photoreceptor 1.

The tone image on the photoreceptor 1 is transferred to a transparent film F by the transfer unit 5.

Onto the transparent film F, an yellow toner image formed by the image forming unit Y, a magenta toner image formed by the image forming unit M, a cyan toner image formed by the image forming unit C, and a black toner image formed by the image forming unit K are superimposingly transferred so that a toner image in multiple colors is formed.

The transparent film F formed with the image in multiple colors passes through a fixing unit 11, the multicolor toner image is fixed, and then the transparent film F is conveyed to paired press rollers 21. On the other hand, a reverse-winding roller 20 feeds out a sheet P having an adhering or tacking layer, and the sheet P is laminated with the transparent film F at the paired press rollers 21. The transparent film F is laminated with the sheet P supplied from the reverse winding roller 20, passes through the paired press rollers 21 and laminated with the sheet P, thereby forming a printed product FP, and the print FP is cut into a predetermined size by a cutter 23.

In the present embodiment, a right toner image of an original image is formed on the photoreceptor 1 by the exposure unit 3, and a mirrored toner image is formed on a transparent film F.

The formed mirror image is backed up by the sheet P and is viewed from the surface side opposite to the image bearing surface of the transparent film F, and accordingly a photograph of a right image is produced.

In the present embodiment, an image processing unit 30 in FIG. 8 reads out image data from an image memory 31 in the same order x1 as that for writing, generates image data 32b, and drives the exposure unit 3.

FIG. 11 is a diagram showing a color image forming apparatus in a third embodiment of the invention.

An image forming section in accordance with the present embodiment has the same structure as that of the image forming section in Embodiment 1.

The present embodiment is different from Embodiment 1 in that a laminating unit 21 and an adhesive or tacking-agent coating unit 25 are incorporated in the image forming section.

In the aforesaid image forming step, a transparent film. F formed with a multi-color toner image is subjected to fixing processing by a fixing device 11, and then passes through paired press rollers 21. On the other hand, by an adhesive or tacking-agent coating unit 25, an adhesive or tacking-agent is coated on the surface of a sheet P supplied by a reverse-winding roller 20, the surface facing the transparent film. Then, the transparent film F and the sheet P are laminated to each other by the paired press roller 21, and then cut by a cutter 23 to a size desired by the user.

In accordance with the invention, as described above, images of desired surface characteristics can be produced, and smooth conveying and stacking of prints can be performed.

What is claimed is:

1. An image forming method, comprising the steps of:
forming a mirror image on a transparent substrate by an electrophotographic process; and
laminating a light reflecting material having an adhering or tacking layer onto an image bearing surface of the transparent substrate,
wherein the transparent substrate and the light reflecting material that are used to form the image satisfy a condition R1⊃R2, R1 indicating a region of the transparent substrate and R2 indicating a region of the light reflecting material.

2. The image forming method of claim 1, comprising the step of cutting a product produced by the laminating step.

3. The image forming method of claim 2, wherein R3 and R4 satisfy a condition R3⊃R4, R3 indicating a region of the mirror image and R4 indicating a region of a printed product cut by the cutting step.

4. The image forming method of claim 3, wherein R1, R2, R3, and R4 satisfy a condition R1⊃R2⊃R3⊃R4.

5. The image forming method of claim 3, wherein R1, R2, R3, and R4 satisfy a condition R1⊃R3⊃R2⊃R4.

6. The image forming method of claim 1, wherein the image is a multiple color image for which plural images are superimposed.

7. The image forming method of claim 1, wherein the transparent substrate comprises a transparent resin film.

8. The image forming method of claim 1, wherein the light reflecting material comprises a paper or a plastic film in a white, translucent white, or silver color.

9. The image forming method of claim 1, wherein the light reflecting material comprises an adhesive or tacking layer.

10. A printed product produced by the image forming method of claim 1.

11. An image forming medium, comprising a transparent substrate in a cut-sheet form and a light reflecting material in a cut-sheet form, wherein a region of the light reflecting material is included in a region of the transparent substrate.

12. An image forming medium, comprising a transparent substrate in a band form and a light reflecting material in a band form, wherein a width of the light reflecting material is smaller than a width of the transparent substrate.

13. An image forming medium, comprising a transparent substrate in a cut-sheet form and a light reflecting material in a band form, wherein a width of the light reflecting material is smaller than a length of a longer side of the transparent substrate.

14. An image forming medium, comprising a transparent substrate in a band form and a light reflecting material in a cut-sheet form, wherein a length of a longer side of the light reflecting material is smaller than at least a longer side of the transparent substrate.

15. The image forming medium of claim 11, wherein the light reflecting material comprises an adhesive or tacking layer.

16. The image forming medium of claim 12, wherein the light reflecting material comprises an adhesive or tacking layer.

17. The image forming medium of claim 13, wherein the light reflecting material comprises an adhesive or tacking layer.

18. The image forming medium of claim 14, wherein the light reflecting material comprises an adhesive or tacking layer.
